(19) United States
(12) Patent Application Publication
(10) Pub. No.: US 2009/0087539 A1
(43) Pub. Date: Apr. 2, 2009

(54) Sustained energy drink

(76) Inventors: Ross G. Fry, Nelson (NZ); Alison J. Thorn, Nelson (NZ); Sharyon M. McIntyre, Nelson (NZ)

Correspondence Address: Robert Charles Hill, 235 Montgomery Street #821, San Francisco, CA, 94104, US

(21) Appl. No.: 11/906,225

(22) Filed: Oct. 1, 2007

(51) Int. Cl. A23L 2/38; A23L 2/02

(52) U.S. Cl. 426/590

(57) ABSTRACT

A method for making a sustained energy beverage comprises mixing together inulin, fruit juices and/or concentrates, and complex carbohydrates from grain dextrins and fruit juice. In a batch method, the mixture is pasteurized, cooled and then stored for use later. A finished beverage is completed by mixing in acids and buffers, and blending. A concentrate is produced that can be sold wholesale, or it can be diluted to 6-22 brix with water. In both the continuous and batch methods, it is pasteurized just before or during bottling to produce a retail sustained energy drink.

### BACKGROUND

1. Field of the Invention

The present invention relates to beverages, and more particularly to black fruit sustained energy drinks that include inulin, anthocyanins, and anti-oxidants. Black fruit are reported to be beneficial to users. This does not exclude the use of other juices as the principal juice.

2. Description of the Prior Art

Most energy drinks today depend on added sugar and/or caffeine to give them a “jolt”, “belt” or “kick”. Unfortunately, when the sugar and caffeine wears off, the users experience a low and feel worse than before they drank the beverage. Simple sugars are well-known for causing sugar crashes.

Muscle tissues require insulin to absorb sugar, but brain tissues do not require insulin and are prime glucose consumers. The liver works to maintain blood sugar levels within a narrow normal range by either absorbing or releasing sugar. It stores sugar as glycogen, and can make sugar from amino acids if food does not supply adequate sugar. A slow absorption of sugars is better tolerated than a rapid absorption of large amounts. Complex carbohydrates from vegetables can provide sustained-release sources of sugar.

Carbohydrates are energy and structural molecules produced by plants. Glucose is the key molecule in living systems and life is built around glucose and its related sugars. Plant foods are essential to animal life, and most human diets. Rice, wheat, potatoes, yams, cassaya, and corn are important staple foods. High-starch vegetables include roots and tubers like potatoes, yams, turnips, winter squash, carrots, and beets. Yams and sweet potatoes are high-caloric root vegetables. Fruits tend to have a high sugar content, mostly glucose, fructose and sucrose. Fruit juices have the highest free-sugar content of all plant foods, except for sugar cane which stores sugar in its stalk. Green leafy vegetables are more chemically diverse and interesting foods that supply less digestible carbohydrate but more vitamins, minerals, and non-digestible fiber.

Several different carbohydrate polymers in fruit and vegetables are not readily digestible. Such passes through as bulk fiber, being modified and then digested by colon microorganisms. Several fibers can absorb and neutralize the irritation or toxicity associated with other foods. Carbohydrate fiber contributes to a well-hydrated bulk of soft, easily-passed stools. Increased dietary fiber over a lifetime is associated with decreased incidence of bowel cancer and cardiovascular disease.

The colon's dense population of microorganisms are very important in health and disease. They feed mostly on undigested carbohydrates, and survive best in the absence of oxygen. About 10-15% of starch from cereal grains, potatoes, and up to 50% of milk sugar in most adults enters the colon undigested. Once there, it will be fermented by colon bacteria. Many vegetables contain indigestible carbohydrates that are well received by the colon flora.

Shelf-life and disease control concerns necessitate that beverages be Pasteurized or otherwise sterilized. But such processes can introduce enough heat to damage inulin, anthocyanins, and anti-oxidants if included in the product. Once damaged, these materials lose their beneficial characteristics.

### SUMMARY OF THE INVENTION

Briefly, a method embodiment of the present invention for making a sustained energy beverage comprises mixing together inulin, fruit juices and/or concentrates, and complex carbohydrates from grain dextrins and fruit juice. In a batch method, the mixture is pasteurized, cooled and then stored for use later. A finished beverage is completed by mixing in acids and buffers, and blending. A concentrate is produced that can be sold wholesale, or it can be diluted to 6-22 brix with water. It is pasteurized just before or during bottling to produce a retail sustained energy drink.

An advantage of the present invention is that a beverage is provided that has sustained energy characteristics.

Another advantage of the present invention is that a beverage is provided that is nutritious.

A further advantage of the present invention is that a method is provided for producing a sustained energy drink.

A still further advantage of the present invention is beverage is provided that can be flavored and colored in many different ways.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a flowchart diagram of a continuous method embodiment of the present invention for making sustained energy beverages; and

FIG. 2 is a flowchart diagram of a batch method embodiment of the present invention for making sustained energy beverages.

### DETAILED DESCRIPTION OF THE PREFERRED EMBODIMENT

Fruit and vegetable juices which may be used in the new sustained energy drink include, but are not limited to all berry fruits, all stone fruits, all citrus fruits, apples, pears, pomegranates, kiwi fruits, bananas, pineapples, coconuts, guavas, passion fruit, grapes, carrots, and currants. Using blackcurrant as the principal fruit, the juice is concentrated to a sugar content of 65-brix by removing enough of its water. Each variety of blackcurrant has a different profile. Magnus has a sharp taste, and Ben Ard has more of a grape flavor. To produce the desired taste profile, different varieties are balanced in the final product. Table-I summarizes the proportions by weight envisioned for a syrup for sustained energy drinks.

Instead of adding sugar to the syrup, a sweet tasting juice like pear or apple concentrate is added to suit local tastes.

TABLE I

| | | |
|---|---|---|
| inulin | carbohydrate fiber | 0.9-19.6% |
| apple or pear | fruit juices for sweetness | 14.5-47.8% |
| juices | | |
| misc. juices | juices for flavoring | 13.0-39.0% |
| ENERGY-SMART | carbohydrate sweetener in syrup | 21.0-67.0% |
| | form made from fruit juices and | |
| | grain dextrins | |
| malic acid | buffer | 0.05-4.0% |
| calcium lactate | buffer | 0.01-3.2% |
| or similar | | |
| ascorbic acid | buffer | 0.001-1.0% |

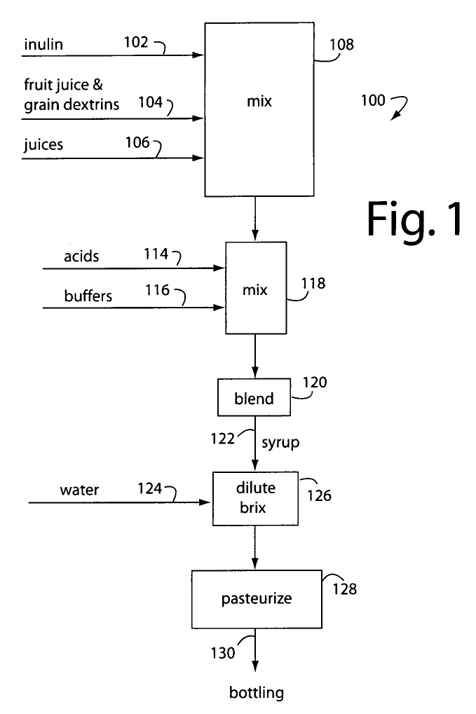

FIG. 1 represents a method embodiment of the present invention for the continuous manufacturing of a beverage syrup or a bottled drink from diluted syrup, and is referred to herein by the general reference numeral 100. The order of the steps is important, as deviations have been seen to produce gelatins and not the syrups suitable for beverage syrups.

Method 100 begins by mixing inulin fiber 102, carbohydrates and grain dextrins 104, and fruit juices 106 together in a mix 108. Inulin fiber 102 is a fructan comprising oligo- and polysaccharides sweeteners, and can be obtained as a soluble powder from Jerusalem artichokes or extracted from chicory (Cichorium intybus) roots. It resists digestion in the upper gastrointestinal tract, and reaches the large intestines where it will be fermented by natural bacteria. Such characteristic is reported to be beneficial for the human colon.

EnergySmart® and EnergySource®, are trademark brands of Advanced Ingredients (Capitola, Calif.), and are fruit concentrate sweeteners. EnergySmart® is described in U.S. Pat. No. 4,873,112, and can be used for carbohydrates and grain dextrins 104. A syrup is produced, and then various acids 114 and buffers 116 are added in a step 118, e.g., malic acid, calcium lactate, and ascorbic acid. The mixture is blended in a step 120 into a syrup 122. Such buffered syrup is diluted with water 124 in step 126 to a target sweetness, e.g., 10-15 brix. It is then pasteurized in step 128 for 5-33 seconds at 60° C. to 92° C. into a bottled consumer drink 130. If glass bottles are used, the drink can be pasteurized in the bottle. If plastic bottles are used, the finished drink is pasteurized just before being bottled.

EnergySource® and other equivalents are acceptable substitutes for EnergySmart® in alternative embodiments of the present invention.

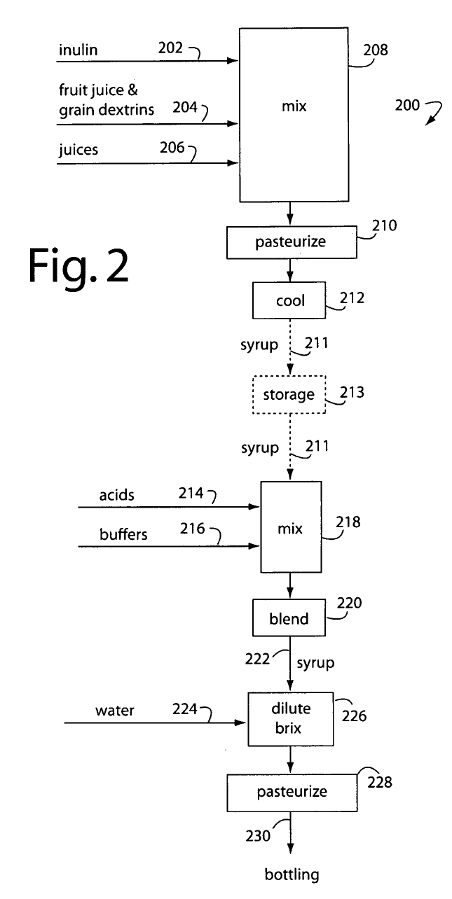

FIG. 2 represents a batch method embodiment of the present invention for the manufacturing of a beverage syrup that can be stored and used later to make a drink from diluted syrup. Such batch method is referred to herein by the general reference numeral 200. Batch method 200 begins by mixing inulin fiber 202, carbohydrates and grain dextrins 204, and fruit juices 206 together in a mix 208. The mixture is pasteurized for 5-33 seconds at 60° C.-92° C. in a step 210, depending on the composition of the fruit juices 206. A syrup 211 is produced when cooled in step 212. A first manufacturing phase in the batch process is concluded by sending the syrup 211 to storage 213 for use later.

The syrup 211 in storage 213 can be sold and used by another manufacturer to complete the production of a beverage.

The beverage is finished after removing the syrup 211 from storage 213 by adding various acids 214 and buffers 216 in a step 218, e.g., malic acid, calcium lactate, and ascorbic acid. These will give the beverage its finished flavors and character. The mixture is blended in a step 220 into a syrup 222. Such buffered syrup is diluted with water 224 in step 226 to a target sweetness, e.g., 20-15 brix. It is then pasteurized again because of the added ingredients in step 228 for 5-33 seconds at 60° C. to 92° C. into a bottled consumer drink 230. If glass bottles are used, the drink can be pasteurized in the bottle. If plastic bottles are used, the finished drink is pasteurized just before being bottled.

In one experiment, 2500 liters of beverage syrup were produced using the method embodiments of the present invention, starting with the ingredients of Table-II.

TABLE II

| | | |
|---|---|---|
| 291 | Kg | inulin |
| 489 | Kg | pear concentrate |
| 394 | Kg | blackcurrant concentrate |
| 1372 | Kg | EnergySmart ® |
| 6.5 | Kg | malic acid |
| 3.4 | Kg | calcium lactate |
| 388 | grams | ascorbic acid |

One drum, about 260-Kg of the resulting syrup was sent to a bottling plant. There, water was added to reconstitute the concentrate juices and reduce the mixture to the desired brix before bottling, about 14-brix. Such was then pasteurized before being used to fill plastic bottles.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A method for continuous manufacturing of a beverage, comprising:
mixing together inulin fiber, complex carbohydrates from fruit juice and grain dextrins, and fruit or vegetable juices;
mixing in acids and buffers;
blending said mixture into a syrup suitable for a sustained energy drink;
diluting said syrup with water to 6-22 brix;
pasteurizing; and
bottling a sustained energy drink for consumer use.

2. The method of claim 1, wherein:
the diluting said syrup with water reconstitutes any concentrate juices used to result in a specific gravity greater than one and about a 14-brix.

3. The method of claim 1, wherein:
the step of mixing comprises using an ENERGYSMART/ENERGYSOURCE equivalent for said complex carbohydrates from fruit juice and grain dextrins.

4. The method of claim 1, wherein:
the step of mixing comprises using blackcurrants for a principal one of said fruit or vegetable juices.

5. The method of claim 1, wherein:
the step of pasteurizing comprises raising temperatures of said mixture to 60° C. to 92° C. for 5-33 seconds.

6. The method of claim 1, wherein:
the step of blending results in a syrup with these constituents and proportions by weight:

| | | |
|---|---|---|
| inulin | carbohydrate fiber | 0.9-19.6% |
| apple or pear | fruit juices for sweetness | 14.5-47.8% |
| juices | | |
| misc. juices | juices for flavoring | 13.0-39.0% |
| ENERGY-SMART | carbohydrate sweetener in syrup | 21.0-67.0% |
| | form made from fruit juices and | |
| | grain dextrins | |
| malic acid | buffer | 0.05-4.0% |
| calcium lactate | buffer | 0.01-3.2% |
| or similar | | |
| ascorbic acid | buffer | 0.001-1.0% |

7. A method for manufacturing a sustained energy drink, comprising:
mixing together (1) inulin fiber, (2) an ENERGYSMART/ENERGYSOURCE equivalent comprising complex carbohydrates from fruit juice and grain dextrins, and blackcurrant as the principal juice;
mixing in acids and buffers; and
blending said mixture into a syrup suitable for a sustained energy drink with these constituents and proportions by weight:

| | | |
|---|---|---|
| inulin | carbohydrate fiber | 0.9-19.6% |
| apple or pear | fruit juices for sweetness | 14.5-47.8% |
| juices | | |
| misc. juices | juices for flavoring | 13.0-39.0% |
| ENERGY-SMART | carbohydrate sweetener in syrup | 21.0-67.0% |
| | form made from fruit juices and | |
| | grain dextrins | |
| malic acid | buffer | 0.05-4.0% |
| calcium lactate | buffer | 0.01-3.2% |
| or similar | | |
| ascorbic acid | buffer | 0.001-1.0% |

diluting said syrup with water to 6-22 brix;
pasteurizing; and
bottling a resulting sustained energy drink for consumer use.

8. A product of the process of claim 7.

9. The method of claim 7 wherein the pasteurizing step raises the temperature to at least 60° C. for at least five seconds.

10. A batch method for manufacturing a beverage, comprising:
mixing together inulin fiber, complex carbohydrates from fruit juice and grain dextrins, and fruit or vegetable juices;
pasteurizing a mixture obtained in the previous step;
cooling said mixture into a syrup; and
storing said syrup for use later in making a beverage.

11. The batch method of claim 10, further comprising:
mixing in acids and buffers; and
blending said mixture into a syrup suitable for a sustained energy drink.
